(19) United States
(12) Patent Application Publication
(10) Pub. No.: US 2010/0096856 A1
(43) Pub. Date: Apr. 22, 2010

(54) APPARATUS AND METHOD FOR GENERATING ELECTRIC POWER FROM A LIQUID CURRENT

(75) Inventors: Phillip Todd Janca, Wichita Falls, TX (US); Phillip Paul Janca, Archer City, TX (US); William Brent Ballard, Olney, TX (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: GULFSTREAM TECHNOLOGIES, INC., Olney, TX (US)

(21) Appl. No.: 12/645,686

(22) Filed: Dec. 23, 2009

Related U.S. Application Data
(63) Continuation-in-part of application No. 12/330,387, filed on Dec. 8, 2008.
Application No. 12/330,387 is a continuation-in-part of application No. 11/519,607, filed on Sep. 12, 2006, now Pat. No. 7,471,006.
(60) Provisional application No. 60/716,063, filed on Sep. 12, 2005.

(30) Foreign Application Priority Data
Jul. 25, 2008 (WO) US200871239
Mar. 2, 2009 (WO) US200935747

(51) Int. Cl. F03B 13/00; H02K 7/18

(52) U.S. Cl. 290/52; 290/54

(57) ABSTRACT

A liquid current power generating system in one embodiment includes a first electric generator, a first vertical rotor operably connected to the first electric generator and extending into a liquid current, and a first turbine operably connected to the first vertical rotor and including at least one first end plate and a first vertical louver with a front side, and a back side, and pivotable between a first position whereat the backside is in contact with a first wall portion of the at least one first end plate, and a second position whereat the backside is in contact with a second wall portion of the at least one first end plate.

This application is a continuation in part application of PCT/US09/35747, filed on Mar. 2, 2009, which is a continuation in part of U.S. patent application Ser. No. 12/330,387, filed on Dec. 8, 2008, which is a continuation in part application of PCT/US08/71239, filed on Jul. 25, 2008, and U.S. patent application Ser. No. 11/519,607, filed Sep. 12, 2006, which issued on Dec. 30, 2008 as U.S. Pat. No. 7,471,006, which claims the benefit of provisional U.S. Patent Application No. 60/716,063, filed on Sep. 12, 2005.

### FIELD

The present invention relates generally to the field of hydroelectric power generation, and, more particularly, to an apparatus and method for generating electric power from a subsurface current.

### BACKGROUND

The wealth of the United States has been created largely through the exploitation of cheap energy provided by the past abundance of fossil fuels. Because of the increasing shortages of natural gas in North America, the continued reliance on oil suppliers located volatile regions, the approaching worldwide shortages of oil, and because of the growing danger of global warming that may be caused by the combustion of fossil fuels, clean reliable sources of renewable energy are needed.

Many of the efforts to develop power generation systems fueled by renewable energy sources have been focused on wind energy. Although wind powered generating systems provide many benefits, they have a significant drawback. Specifically, wind direction and speed are in a constant state of flux. Wind speeds can fluctuate hourly and have marked seasonal and diurnal patterns. They also frequently produce the most power when the demand for that power is at its lowest. This is known in the electricity trade as a low capacity factor. Low capacity factors, and still lower dependable on-peak capacity factors, are notable shortcomings of wind power generation.

In contrast to the winds, rivers and streams provide a relatively stable current. Additionally, some deep ocean currents are driven largely by relatively steady Coriolis forces. The fact that such ocean currents are not subject to significant changes in direction or velocity makes sub-sea power generation somewhat more desirable than the intermittent power produced by wind-driven turbines. The book, Ocean Passages of the World (published by the Hydrographic Department of the British Admiralty, 1950), lists 14 currents that exceed 3 knots (3.45 mph), a few of which are in the open ocean. The Gulf Stream and the Kuro Shio are the only two currents the book lists having velocities above 3 knots that flow throughout the year. Both of these currents are driven by the Coriolis force that is caused by the Earth's eastward rotation acting upon ocean currents produced by surface trade winds. Because these currents are caused largely by the Earth's rotation, they should remain constant for a substantial period barring significant changes in local geography.

The Gulf Stream starts roughly in the area where the Gulf of Mexico narrows to form a channel between Cuba and the Florida Keys. From there the current flows to the northeast through the Straits of Florida, between the mainland of the United States and the Bahamas, flowing at a substantial speed for some 400 miles. The peak velocity of the Gulf Stream is achieved off of the coast of Miami, Fla., where the Gulf Stream is about 45 miles wide and 1,500 feet deep. There, the current reaches speeds of as much as 6.9 miles per hour at a location between Key Largo, Fla. and North Palm Beach, Fla., and less than 18 miles from shore. Farther along it is joined by the Antilles Current, coming up from the southeast, and the merging flow, broader and moving more slowly, continues northward and then northeastwardly, as it roughly parallels the 100-fathom curve as far as Cape Hatteras, N.C.

The Kuro Shio is the Pacific Ocean's equivalent to the Gulf Stream. A large part of the water of the North Equatorial current turns northeastward east of Luzon and passes the east coast of Taiwan to form this current. South of Japan, the Kuro Shio flows in a northeasterly direction, parallel to the Japanese islands, of Kyushu, Shikoku, and Honshu. According to Ocean Passages of the World, the top speed of the Kuro Shio is about the same as that of the Gulf Stream. The Gulf Stream's top flow rate is 156.5 statute miles per day (6.52 mph) and the Kuro Shio's is 153 statute miles per day (6.375 mph).

Other possible sites for subsurface generators are the East Australian Coast current, which flows at a top rate of 110.47 statute miles per day (4.6 mph), and the Agulhas current off the southern tip of South Africa, which flows at a top rate of 139.2 statute miles per day (5.8 mph). Another possible site for subsurface generators is the Strait of Messina, the narrow opening that separates the island of Sicily from Italy, where the current's steady counter-clockwise rotation is produced primarily by changing water densities resulting from evaporation in the Mediterranean. Oceanographic current data may suggest other potential sites.

Submersible turbine generating systems can be designed to efficiently produce power from currents flowing as slowly as 3 mph—if that flow rate is consistent—by increasing the size of the turbines in relation to the size of the generators, and by adding more gearing to increase the shaft speeds to the generators. Because the Coriolis currents can be very steady, capacity factors of between 70 percent and 95 percent may be achievable. This compares to historical capacity factors for well-located wind machines of between 23 percent and 30 percent. Because a well-placed submersible turbine will operate in a current having even flow rates, it may possible for it to produce usable current practically one hundred percent of the time.

In addition to natural current, a variety of manmade current sources are available. By way of example, various factories, power generation facilities, etc, utilize water. The water is generally directed from a naturally occurring waterway to the point of use by artificial channels. After the water has been used, the water is returned to a natural body of water by additional manmade channels. A pump is used in many instances to generate a current thereby moving the water along the supply route while gravity flow is used to return the water to the natural body of water. The artificial channel may be open to the atmosphere or it may be a closed channel, such as a pipe.

One example of a fluid which is typically enclosed within a pipe is oil. Oil and other fluids are transported over long distances in pipelines. As the pipelines age, they must be inspected and serviced. Since the pipelines are routed through areas which are far from population centers, locations which need to be serviced are frequently far removed from any source of usable energy. Accordingly, significant cargo space is used merely to ensure power is available at remote areas. Additionally, reporting stations, monitoring stations, etc. may be located along the pipeline. Power for these stations is generally provided by generators which must be re-fueled. Repeated transportation of fuel to remote stations is expensive and time consuming.

Accordingly, a power generating system that can use fluid current would be useful. A system that can be used with manmade current systems would be further beneficial.

### SUMMARY

A subsurface power generating system in one embodiment includes a first electric generator, a first vertical rotor operably connected to the first electric generator and extending into a liquid current, and a first turbine operably connected to the first vertical rotor and including at least one first end plate and a first vertical louver with a front side, and a back side, and pivotable between a first position whereat the backside is in contact with a first wall portion of the at least one first end plate, and a second position whereat the backside is in contact with a second wall portion of the at least one first end plate.

In another embodiment, a method of generating electrical power from a liquid current includes positioning a first louver within a liquid current, impinging a front side of the first louver with the liquid current to transfer a first force to the first louver, pivoting a backside of the first louver into contact with a first end plate wall structure using the first force, impinging the back side of the first louver with the water current to transfer a second force to the first louver, pivoting the back side of the first louver into contact with a second end plate wall structure using the second force, and rotating a first vertical rotor operably connected to a first electrical generator with the transferred first force and the transferred second force.

In yet another embodiment, a power generating system includes a first turbine operably connected to a first vertical rotor and including a first end plate and a first louver with a front portion, and a back portion, the first louver pivotable between a first position whereat the back portion is in contact with a first wall portion of the first end plate, and a second position whereat the back portion is in contact with a second wall portion of the first end plate, and a first vertical pivot extending through the first louver and defining a first axis of rotation for the first louver such that the distance from the first axis of rotation to a leading end of the first louver is shorter than the distance from the first axis of rotation to a trailing end of the first louver.

The above-noted features and advantages of the present invention, as well as additional features and advantages, will be readily apparent to those skilled in the art upon reference to the following detailed description and the accompanying drawings, which include a disclosure of the best mode of making and using the invention presently contemplated.

### BRIEF DESCRIPTION OF THE DRAWINGS

FIG. 1 depicts a perspective view of another exemplary electric power generation station in accordance with principles of the present invention;

FIG. 2 depicts a perspective view of the submerged cage portion of the system of FIG. 1 with two vertical rotor, counter-rotating turbines;

FIG. 3 depicts a perspective view of one of the turbines of FIG. 2;

FIG. 4 depicts a perspective view of an end plate of the turbine of FIG. 3 showing louver receiving areas;

FIG. 5 depicts a plan view of the lower end plates and self-aligning louvers of the turbines of FIG. 2 showing the movement and position of the louvers in the primary drive zones, secondary drive zones, and the flutter zones of the turbine as the turbines rotate;

FIG. 6 depicts a perspective view of an alternative end plate that may also be used as a strengthening web;

FIG. 7 depicts a perspective view of a bushing that may be used to increase the efficiency of a turbine;

FIG. 8 depicts a perspective view of a louver with internal cavities to increase the strength of the louver and to reduce the weight of the louver;

FIG. 9 depicts a perspective view of an embodiment of a turbine with louvers which self-align into louver blades using pivot pins to limit pivoting of the louvers;

FIG. 10 depicts the lower end plate and self-aligning louvers of the turbine of FIG. 9 showing the movement and position of the louvers in the primary drive zones, secondary drive zones, and the flutter zones of the turbine as the turbine rotates;

FIG. 11 depicts a perspective view of an embodiment of a turbine with fixed louvers which extend helically about a central shaft;

FIG. 12 depicts a top cross-sectional view of the turbine of FIG. 11 showing five fixed helically extending louvers;

FIG. 13 depicts a perspective view of an embodiment of a turbine with fixed louvers which extend helically about a central shaft;

FIG. 14 depicts a top cross-sectional view of the turbine of FIG. 13 showing three fixed helically extending louvers;

FIG. 15 depicts a perspective view of the submerged cage portion of the system of FIG. 1 with two vertical rotors, counter-rotating fixed louver turbines and baffles mounted on the cage portion to increase the efficiency of the turbines;

FIG. 16 depicts a side cross-sectional view of another exemplary liquid current electric power generation station in accordance with principles of the present invention;

FIG. 17 depicts a plan view of the liquid current electric power generation station of FIG. 16;

FIG. 18 depicts a top plan view of the electric power generation station of FIG. 16 positioned within a current and with the deck removed;

FIG. 19 depicts a partial top cutaway view of another exemplary liquid current electric power generation station in accordance with principles of the present invention;

FIG. 20 depicts a partial side cutaway view of the liquid current electric power generation station of FIG. 19;

FIG. 21 depicts a partial side cutaway view of another exemplary liquid current electric power generation station in accordance with principles of the present invention;

FIG. 22 depicts a front view of the liquid current electric power generation station of FIG. 19;

FIG. 23 depicts a front view of another exemplary liquid current electric power generation station in accordance with principles of the present invention;

FIG. 24 depicts a partial top cutaway view of another exemplary liquid current electric power generation station in accordance with principles of the present invention; and

FIG. 25 depicts a side plan view of another exemplary liquid current electric power generation station in accordance with principles of the present invention.

### DETAILED DESCRIPTION

Like reference numerals refer to like parts throughout the following description, the accompanying drawings, and the claims.

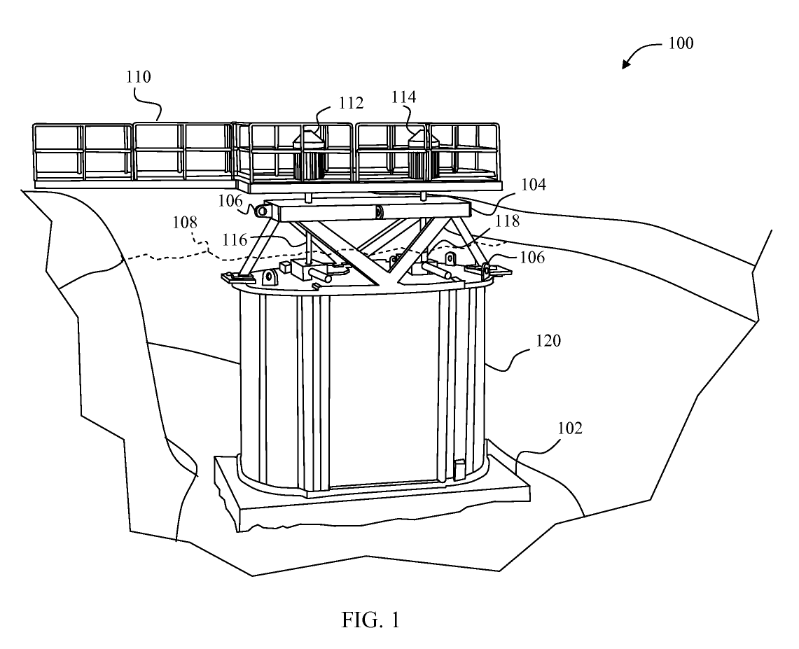

FIG. 1 depicts a perspective view of an exemplary subsurface power generation station 100. The subsurface power generation station 100 includes a base 102 and a frame 104. The base 102 functions as an anchor to maintain the power generation station 100 at a desired location in a subsurface current. The frame 104 includes a number of padeyes 106 which are used to position the power generation station 100 in the liquid current which in FIG. 1 is a water current. The padeyes 106 may be used by a ship to lower the power generation station 100 into a location removed from land or by a crane to position the power generation station 100 in a river, stream, or ocean current close to land.

The frame 104 extends from the base 102 to a location above the water surface 108. In this embodiment, the frame 104 supports a gangway 110 which is used to provide access to the power generation station 100 and to run power lines from the power generation station 100 to a load. The frame 104 further supports two generators 112, and 114 which are powered by vertical rotor shafts 116 and 118, respectively. The generators 112 and 114 in this embodiment are 5 kW LIMA®MAC generators commercially available from Marathon electric Manufacturing Corp., of Wausau, Wis. If desired, more than one generator may be powered by each of the vertical rotor shafts 116 and 118 through a clutch system as described in PCT/US09/35747, filed on Mar. 2, 2009, the entire contents of which are herein incorporated by reference.

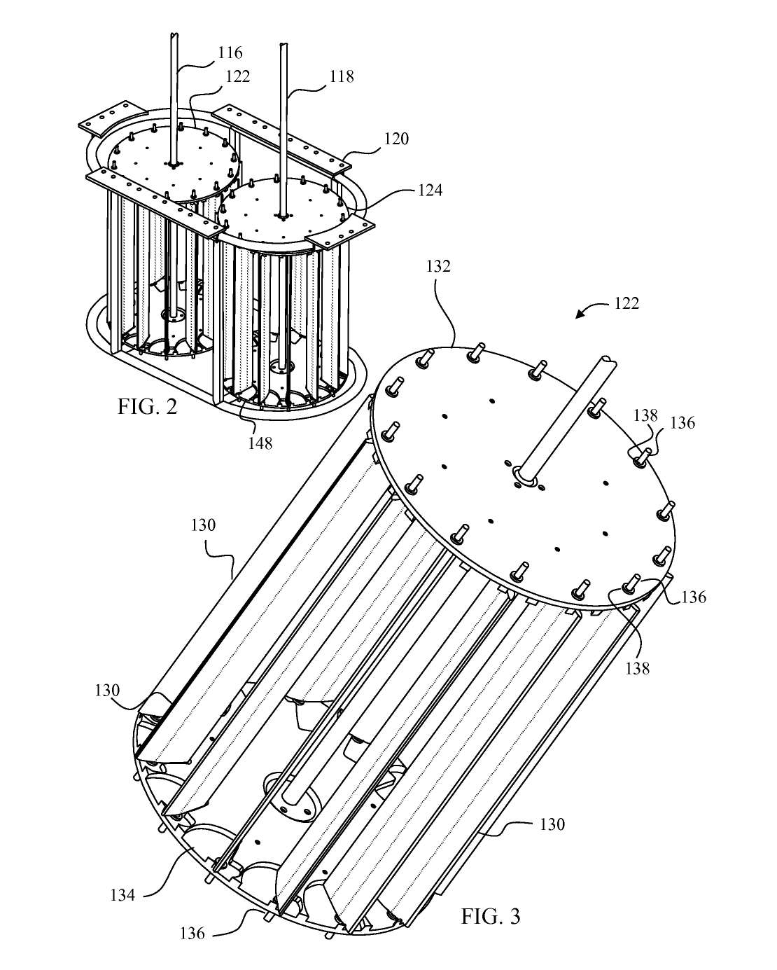

The vertical rotor shafts 116 and 118 extend from the generators 112 and 114, respectively, into a cage portion 120 of the frame 104 whereat the rotor shafts 116 and 118 are coupled to two vertical axis turbines 122 and 124, respectively, as shown in FIG. 2. The turbines 122 and 124 are substantially identical and are described with initial reference to turbine 122 shown in FIG. 3. The turbine 122 includes a number of louvers 130 extending between two end plates 132 and 134. Each of the louvers 130 are pivotally connected to the end plates 132 and 134 by a respective pivot bar 136. Each of the pivot bars 136 pivot within a pivot hole 138 located in the end plates 132 and 134.

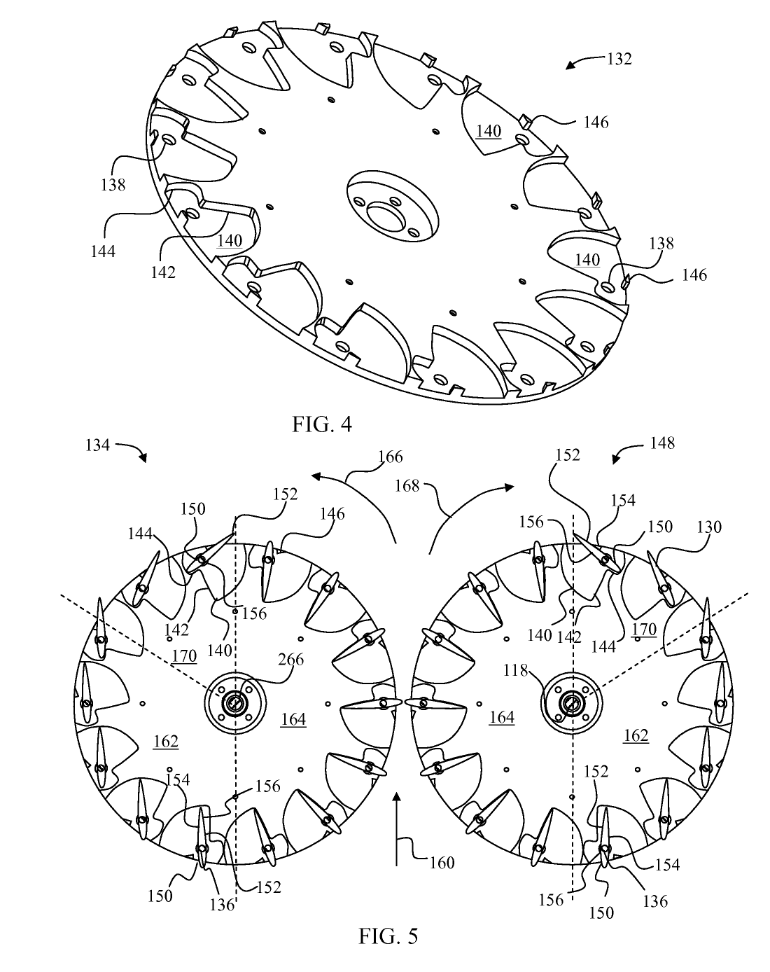

With reference to FIG. 4, the end plate 132 includes a number of receiving areas 140. Each receiving area 140 includes one pivot hole 138, a trailing portion pivot limiting wall 142, a leading portion pivot limiting wall 144, and a stabilizer 146. When viewed in plan, the leading portion pivot limiting wall 144 of the upper most receiving area 140 opens to the right of the trailing portion pivot limiting wall 142. Accordingly, the end plate 132 is a clockwise end plate as described more fully below. Each of the receiving areas 140 receives one louver 130 as shown in FIG. 5. The opposing end plate 134 is complimentarily formed with receiving areas. If desired, an intermediate web may be provided with the louvers extending through cutout portions of the web to provide additional stiffness.

FIG. 5 depicts the end plate 134 and the end plate 148 of the turbine 124. The end plate 2134 is a counterclockwise end plate while the end plate 148 is a clockwise end plate. The pivot bars 136 divide each of the louvers 130 into a leading edge portion 150 which is shorter than a trailing edge portion 152. A front side 154 extends between the leading edge portion 150 and trailing edge portion 152 on one side of each of the louvers 130 and a back side 156 is located opposite the front side 154. The back sides 156 of the louvers 130 are the sides of the louvers 130 which contact the trailing portion pivot limiting walls 142. Thus, as shown in FIG. 5, while the louvers 130 on the turbine 122 are identical to the louvers 130 on the turbine 124, the back sides 156 of the louvers 130 on the turbine 122 are reversed from the back sides 156 of the louvers 130 on the turbine 124.

Operation of the power generation system 100 is described with reference to FIGS. 1-5. Initially, the frame 104 is lowered into a liquid body with a current flow until the base 102 is resting on the bottom of the water feature and the cage portion 120 is at least partially submerged. In this embodiment, the generators 112 and 114 are preferably located above the water surface 108.

In a preferred orientation, the frame 104 is positioned such that a line extending from the vertical rotor shaft 116 to the vertical rotor shaft 118 is perpendicular to the current flow. Accordingly, a current moving in the direction of the arrow 160 in FIG. 5 will drive both turbines 122 and 124 with about the same force. As the current impinges on the louvers 130, the louvers 130 rotate through three operational zones. In a flutter zone 162, the louvers are constrained by the pivot bars 136 but they are not constrained by the receiving areas 140. Accordingly, the louvers 130 self-orient to a position of least resistance to the incoming current, with the leading edge portions 150 pointed into the incoming current.

As the turbines 122 and 124 rotate, the louvers 130 within the flutter zone 162 pivot about a pivot axis defined by the pivot bars 136. Accordingly, the back sides 156 of the trailing edge portions 302 of the louvers 280 pivot closer to the trailing portion pivot limiting walls 142. As the louvers 130 are rotated out of the flutter zone 162, they enter a primary drive zone 164. In the primary drive zone 164, the back sides 156 of the trailing edge portions 152 of the louvers 130 come into contact with the trailing portion pivot limiting walls 142.

Accordingly, as the current moves in the direction of the arrow 160, kinetic energy from the current is transmitted through the louvers 130 to the trailing portion pivot limiting walls 142 within the primary drive zone 164. In embodiments including intermediate webs, kinetic energy from the current is also transmitted through the louvers 130 to the intermediate web. The transferred kinetic energy causes the turbines 122 and 124 to rotate. The end plate 134 of the turbine 122 (the lower end plate) is a counterclockwise end plate. Accordingly, the current impinging upon the louvers 130 in the turbine 122 causes rotation of the turbine 122 in the direction of the arrow 166. The end plate 148 of the turbine 124 (the lower end plate) is a clockwise end plate. Accordingly, the current impinging upon the louvers 130 in the turbine 124 causes rotation of the turbine 124 in the direction of the arrow 168.

Transfer of kinetic energy from the current through the louvers 130 continues throughout the primary transfer zone 164. As the louvers 130 are rotated toward a secondary transfer zone 170, the longitudinal axes of the louvers 130 (as viewed in cross-section) align with the direction of the current. Once the louvers 130 are rotated into the secondary transfer zone 170, the current passing through the turbines 122 and 124 impinges the back sides 156 of the louvers 130. The impinging current forces the louvers 130 to pivot. Pivoting of the louvers 130 continues until the leading edge portions 150 of the louvers 130 contact the leading portion pivot limiting walls 144. In this embodiment, the stabilizers 146 are configured such that the front sides 154 of the louvers 130 contact the stabilizers 146 as the leading edge portions 150 of the louvers 130 contact the leading portion pivot limiting walls 144.

Once the louvers 130 have pivoted into contact with the stabilizers 146 and the leading portion pivot limiting walls 144, additional kinetic energy is transferred through the louvers 130 to the stabilizers 146 and the leading portion pivot limiting walls 144, providing additional torque to the turbines 122 and 124.

Accordingly, the louvers 130 are self-aligning to maximize transfer of kinetic energy from the current to the turbines 122 and 124 through the primary drive zone 164 and the secondary drive zone 170, while minimizing drag through the flutter zone 162.

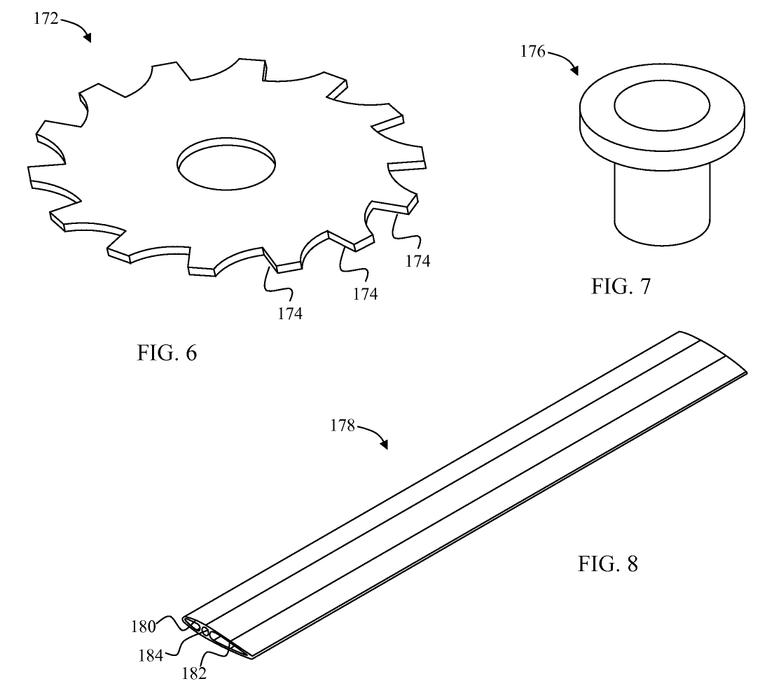

Other modifications may be incorporated to provide enhanced efficiency of the various turbines described herein. By way of example, FIG. 6 depicts a perspective view of a plate 172 that includes trailing portion pivot limiting walls 174. The plate 172 may be used as a portion of an end plate in a turbine or as an intermediate web to provide additional support for louvers. In turbine versions which are exposed to higher stresses and/or applications exposed to particularly harsh environments such as sea water, the plate 172 and the other plates described herein may be fabricated from a stainless steel. In smaller versions, particularly those not exposed to water with high salinity, a polymer or castable urethane, such as VIBRATHANE or ADIPRENE, commercially available from Chemtura Corporation, of Middlebury, Conn., may be incorporated in manufacturing the plate 172.

The efficiency of turbines may also be enhanced by the inclusion of bushings between components that move with respect to each other. For example, bushing 176 of FIG. 7 may be used in the various end plates described herein. The bushing 176 may also be fabricated incorporating VIBRATHANE or ADIPRENE.

Further efficiencies may be effected by decreasing the weight of the louvers. To this end, the louver 178 shown in FIG. 8 includes a leading portion cavity 180 and a trailing portion cavity 182 in addition to a shaft cavity 184. The cavities 180 and 182, which may be filled with a fluid or gas to provide a desired buoyancy, allow the weight of the louver 178 to be modified to a desired weight. Additionally, the cavities provide increased strength and stiffness for the louver 11778. While stainless steel may be used to fabricate the louver 178 in certain applications, smaller versions of the louver 178 may be extruded using aluminum to further decrease the weight of the louver 178. By way of example, 6063 aluminum alloy may be used and heat treated to exhibit properties of T6 condition. Polymers such as those discussed above may be used to coat the louvers to provide additional desired properties.

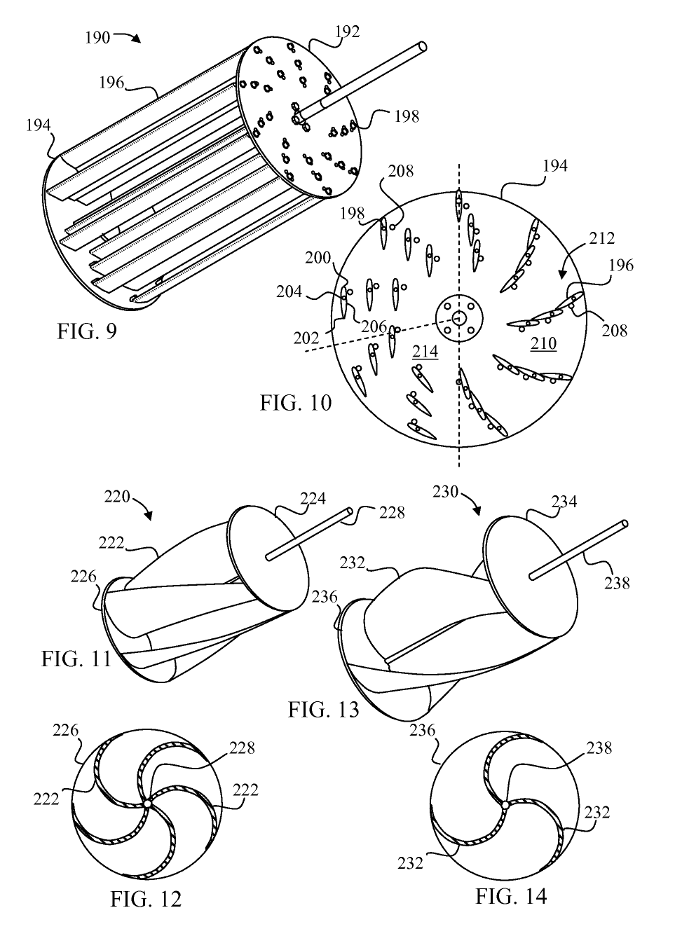

FIG. 9 depicts an alternative turbine 190 that may be used to generate power from a liquid current. The turbine 190 includes two end plates 192 and 194 which support a number of louvers 196. The louvers 196 are pivotally connected to the end plates 3192 and 194 by pivot bars 198, also shown in FIG. 10. The pivot bars 198 define a pivot axis which is located between a leading edge portion 200 and a trailing edge portion 202. The louvers 196 further include a front side 204 and a back side 206.

The turbine 190 operates in a manner similar to the turbines 122 and 124. One difference between the turbine 190 and the turbines 122 and 124 is that the end plates 192 and 194 do not include a receiving area. Rather, pivoting of the louvers 196 is constrained by an associated pivot pin 208 shown in FIG. 10 and, for most of the louvers 196, the leading edge portion 200 of the front side 204 of an adjacent louver 196. More specifically, the pivot pins 208 are positioned such that as the backside 206 of an associated first louver 196 contacts the associated pivot pin 208, the trailing edge portion 202 of the backside 206 also contacts the leading edge portion 200 of the front side 204 of an adjacent second louver 196 located inwardly of the first louver 196.

Accordingly, as the louvers 196 are rotated through a primary drive zone 210, adjacent louvers 196 form a louver blade 212. As the louvers 196 are rotated into a secondary drive zone 214, the louvers 196 pivot in a clockwise direction, as viewed in FIG. 10, and kinetic energy from an incoming current is transferred through the backside 206 of the leading edge portion 200 to the associated pivot bar 198.

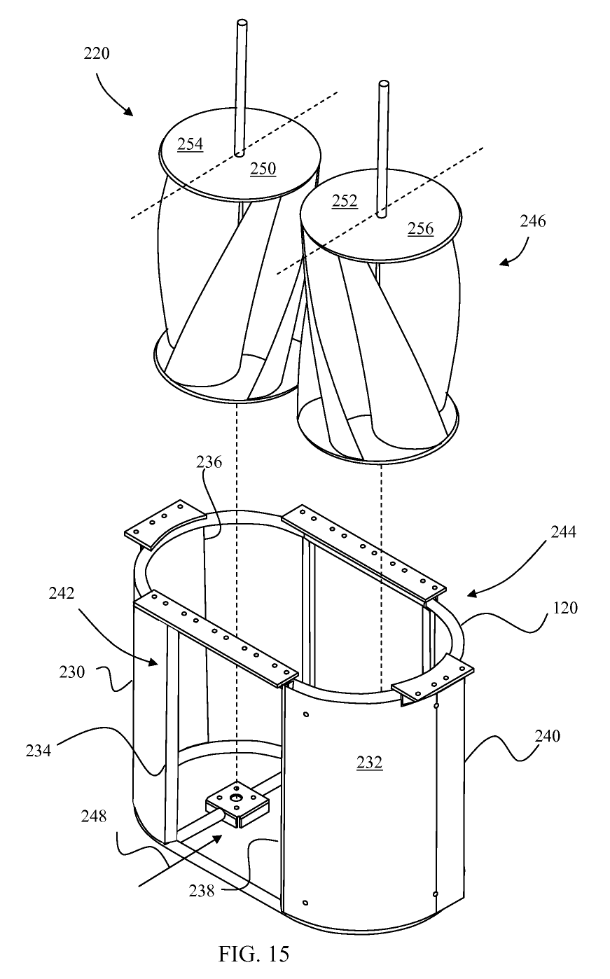

In other embodiments, fixed louver turbines are used to generate power from a liquid current. By way of example, FIGS. 11 and 12 depict a turbine 220 that includes five fixed louvers 222. The louvers 222, which extend between end plates 224 and 226, are helically formed about a vertical shaft 228. If desired, more or fewer fixed louvers may be used. Thus, the turbine 230 shown in FIGS. 13 and 14 includes three fixed louvers 232. The louvers 232, which extend between end plates 234 and 236, are helically formed about a vertical shaft 238.

When a turbine with fixed louvers is used, a baffle may be used to increase the efficiency of the turbine. By way of example, the cage portion 120 of the frame 104 of FIGS. 1 and 2 is shown in FIG. 15 with baffles 230 and 232 attached thereto. Baffle 230 includes a forward lip 234 and a rear portion 236. Baffle 232 includes a forward lip 238 and a rear portion 240. The opposing lips 234 and 238 define a mouth 242 of the cage portion 120 and the rear portions 236 and 240 define a discharge 244.

Also shown in FIG. 15 are turbines 220 and 246. The turbine 220 is configured to rotate in a counterclockwise direction as shown in FIG. 15 when impinged by a current moving in the direction of the arrow 248. The turbine 246 is configured to rotate in a clockwise direction as shown in FIG. 15 when impinged by a current moving in the direction of the arrow 248. When the turbines 220 and 246 are installed in the cage portion 120 and placed in a current, the current is directed by the baffles 230 and 232 through the mouth 242 against the louvers 222 in the primary drive zones 250 and 252 of the turbines 220 and 246. Water which passes through the cage portion 120 is discharged through the discharge 244. The baffles 230 and 232 further deflect current about the cage portion 120 such that the current does not directly impinge the louvers 222 in the non-primary drive zones 254 and 256, thereby reducing drag and increasing the efficiency of the turbines 220 and 246.

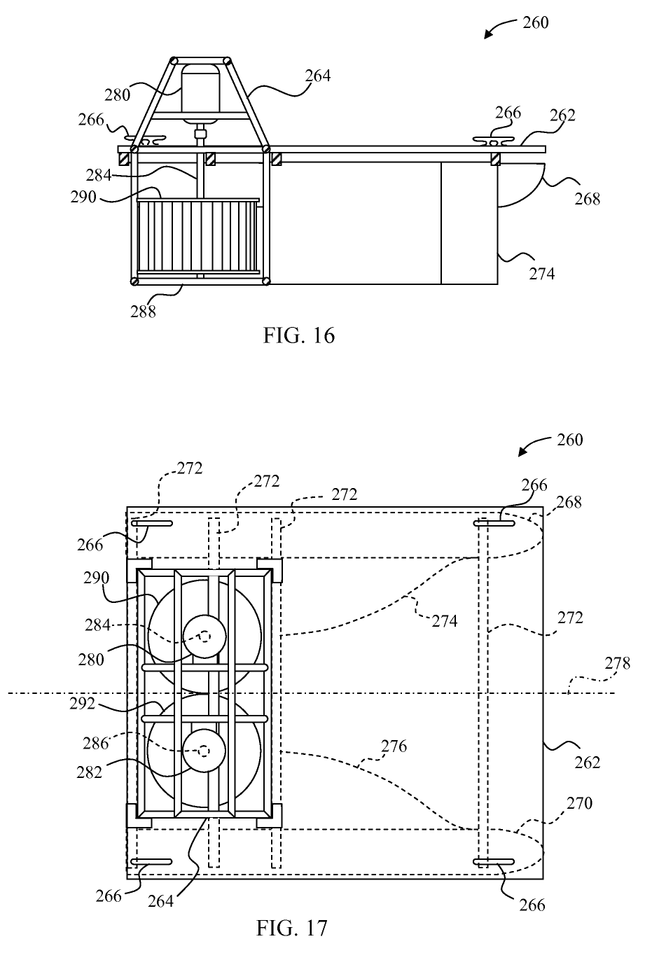

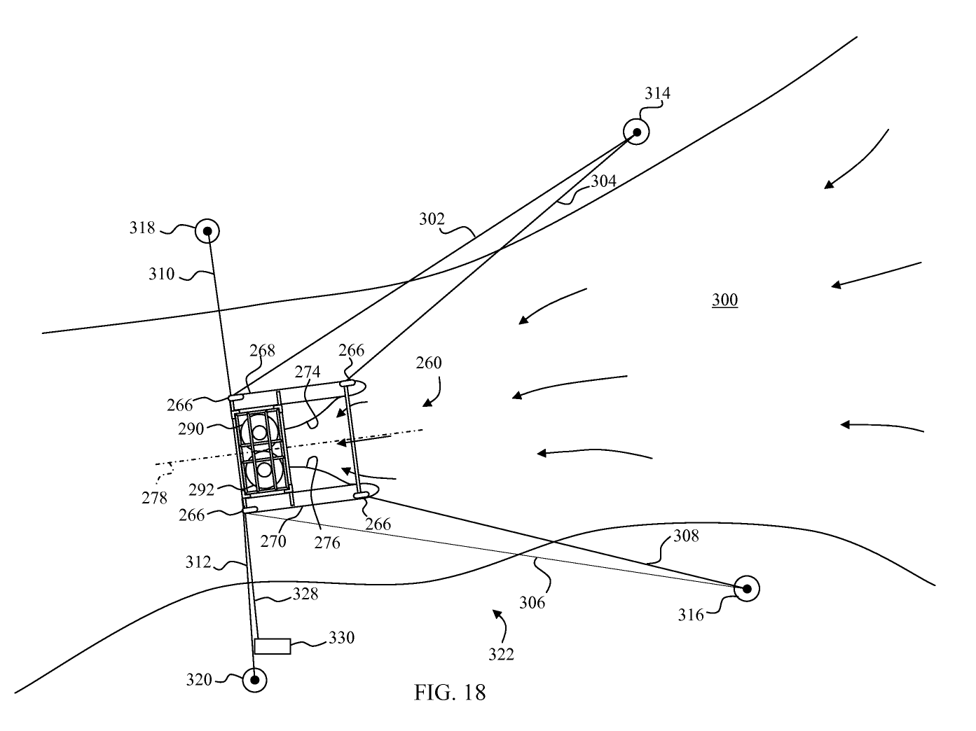

An alternative liquid current power generation station 260 is depicted in FIGS. 16 and 17. The liquid current power generation station 260 includes a base or deck 262 and a frame 264. A number of cleats 266, which are used to position and maintain the power generation station 260 in the current as discussed below, are provided on the deck 262.

The deck 262 extends from a first pontoon 268 to a second pontoon 270 that is spaced apart from the first pontoon 268. Four cross bars 272 extend between the pontoons 268 and 270. Two baffles 274 and 276 are connected to the pontoons 268 and 270, respectively. The baffles 274 and 276 curve inwardly toward the centerline 278 of the power generation station 260.

Two generators 280 and 282 are supported within the frame 264. The generators 280 and 282 may be the same type as the generators 112 and 114 of the power generation station 100. Two vertical shafts 284 and 286 are coupled to the generators 280 and 282, respectively, and rotatably supported by a base 288. Each of the vertical shafts 284 and 286 are coupled to a respective vertical axis turbine 290 and 292. The vertical axis turbines 290 and 292 may be substantially identical to the vertical axis turbines 122 and 124.

The power generation station 260 may be operated in substantially the same manner as the power generation station 100. Additional capabilities, however, are provided by various components of the power generation station 260. For example, pontoons 268 and 270 allow the power generation station 260 to be transported by a trailer and launched into a body of water or other liquid current. The pontoons 268 and 270 are sized to maintain the deck 272 and the generators 280 and 282 above the liquid current. Lines may then be attached to the cleats 266 and used to maneuver the power generation station 260 into a desired position in the liquid current. Alternatively, a motor may be attached to the deck 262 and used to position the power generation station 260.

In addition to allowing rapid deployment, the location and orientation of the power generation station 260 within a liquid current is easily optimized. By way of example, the power generation station 260, depicted in FIG. 18 with the deck 262 removed for sake of clarity, is secured within a liquid current 300 by two port side spring lines 302 and 304 and two starboard side spring lines 306 and 308, each of which is coupled to one of the cleats 266. A port side breast line 310 and a starboard side breast line 312 are also coupled to the cleats 266. The spring lines 302 and 304 are further coupled to a stanchion 314 and the spring lines 306 and 308 are coupled to a stanchion 316. The breast lines 310 and 312 are coupled with stanchions 318 and 320, respectively. Alternatively, the breast lines 310 and 312 and the spring lines 302, 304, 306, and 308 may be coupled to other convenient structures.

The spring lines 302, 304, 306, and 308 are used to position the power generation station 260 at a location within the current 300 whereat the current 300 is optimal. In the example of FIG. 18, a naturally occurring neck 322 concentrates the current 300. The breast lines 310 and 312 are then used to orient the centerline 278 of the power generation station 260 with the incoming current 300 to maximize the amount of power generated by the power generation station 260.

The baffles 274 and 276 are configured to further concentrate the incoming current 300 and to optimize the angle at which the current 300 impinges the vertical axis turbines 280 and 282. If desired, the baffles 274 and 276 may be configured to be stored at a location above the water level to increase maneuverability of the power generation station 260 and lowered once the power generation station 260 is positioned at the desired location within the current 300.

An electrical cable 328 is used to couple the power generation station 260 to a substation 330. The cable 328 may be supported with the breast line 312. The subsurface power generation station 260 may then be used to generate electrical power.

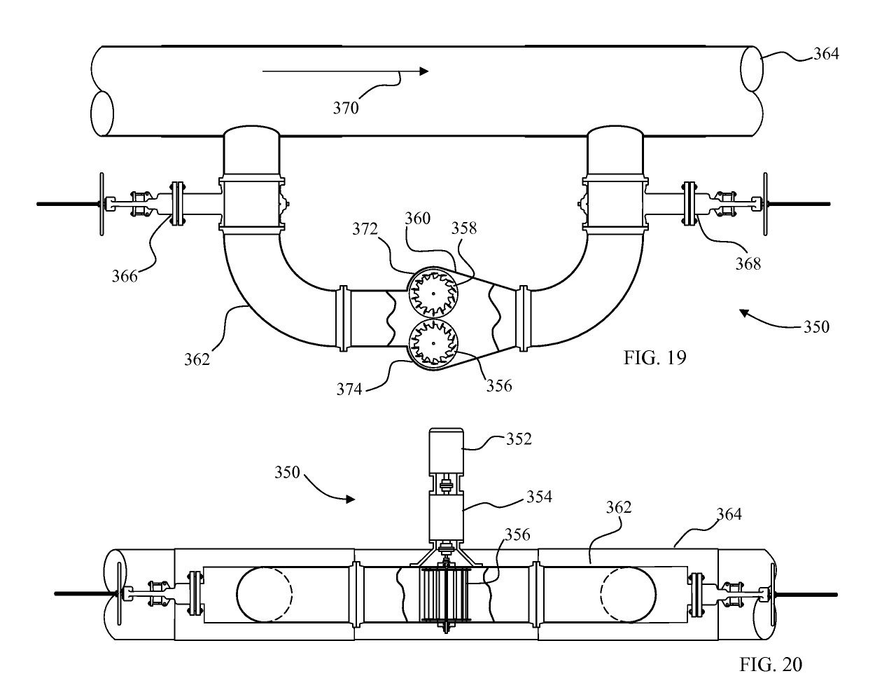

An alternative liquid current power generation station 350 is depicted in FIGS. 19 and 20. The liquid current power generation station 350 includes two generators 352 (only one is shown), two gearboxes 354 (only one is shown), and two vertical axis turbines 356 and 358. The generators 352 may be the same type as the generators 112 and 114 of the power generation station 100 and the vertical axis turbines 356 and 358 may be substantially identical to the vertical axis turbines 122 and 124. The turbines 356 and 358 are located within a node 360 in a bypass 362. The bypass 362 is isolated from a main pipeline 364 by two block valves 366 and 368.

The power generation station 350 may be operated in substantially the same manner as the power generation station 100. The power generation station 350 may be isolated from a current within the pipeline 364, however, by the block valves 366 and 368. Accordingly, the vertical axis turbines 356 and 358 may be isolated from the main pipeline for maintenance or when not in use.

To place the power generation station 350 in service, the block valve 368 is opened and then the block valve 366 is opened. Consequently, a portion of the liquid flowing in the direction of the arrow 370 in the pipeline 364 is allowed to enter the bypass 362 and rotate the turbines 356 and 358. To discontinue operation of the power generation station 350, the block valve 366 is shut. Block valve 368 may remain open to ensure the bypass 362 does not become over pressurized.

The efficiency of the power generation station 350 is enhanced by the configuration of the node 360. Specifically, the node 360 includes two shoulders 370 and 372 which extend outwardly from the pipe in the bypass 362. The turbines 356 and 358 are positioned within the node 360 such that the flutter zones of the turbines 356 and 358 are positioned within areas defined by the shoulders 370 and 372. Fluid within the bypass is thus directed to the primary and secondary drive zones of the turbines 356 and 358.

In some embodiments sufficient current through the bypass 362 may be achieved merely by opening the inlet block valve 366. In other embodiments, a diverter may be positioned within the pipeline 364 to provide additional flow through the bypass 362.

The power generation station 350 may thus be placed into service only when needed, providing a convenient source of power even in remote locations. Moreover, the power generation station 350 may be retrofit into existing pipelines with relatively little impact on the operation of the pipeline by provision of hot tap tees on the inlet and outlet of the bypass 362.

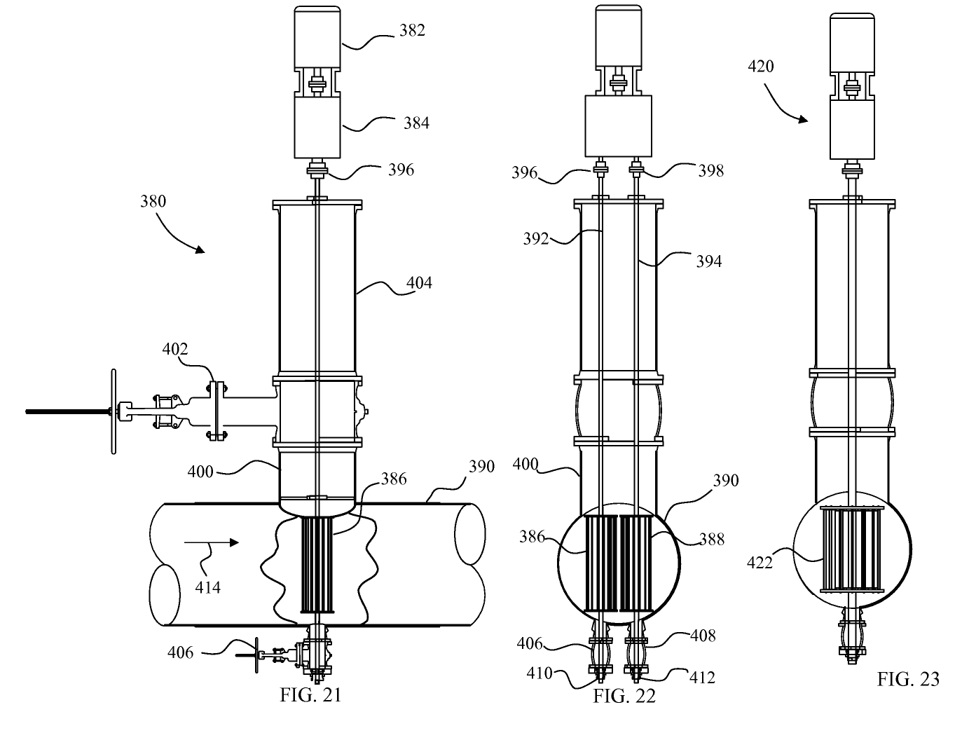

Another alternative liquid current power generation station 380 is depicted in FIGS. 21 and 22. The liquid current power generation station 380 includes a generator 382, a gearbox 384, and two vertical axis turbines 386 and 388. The generator 382 may be the same type as the generators 112 and 114 of the power generation station 100 and the vertical axis turbines 386 and 388 may be substantially identical to the vertical axis turbines 122 and 124. The turbines 386 and 388 are located within a pipeline 390.

The turbines 386 and 388 are connected to the gearbox 384 by two shafts 392 and 394 through two couplings 396 and 398, respectively. The shafts 392 and 394, as depicted in FIGS. 21 and 22, extend through a hot tap tee 400, past a block valve 402 and through a storage chamber 404. The shafts 392 and 394 also extend downwardly past two block valves 406 and 408 and rest on two bearing seals 410 and 412, respectively.

The power generation station 380 may be operated in substantially the same manner as the power generation station 100. The power generation station 380 may be isolated from a current within the pipeline 364, however, by moving the turbines 386 and 388 upwardly into the storage chamber 404. Repositioning of the turbines 386 and 388 may be aided by the provision of a hydraulic lift system (not shown). Additionally, the shafts 392 and 394 may be disconnected from the gearbox 384 by way of the couplings 396 and 398. Once the turbines 386 and 388 are positioned within the storage chamber 404, the block valves 402, 406, and 408 may be shut to isolate the pipeline. Accordingly, the vertical axis turbines 386 and 388 may be isolated from the main pipeline for maintenance or when not in use.

To place the power generation station 380 in service, the block valves 402, 406, and 408 are opened. The turbines 386 and 388 are then lowered into the pipeline 390. If desired, the turbines may be lowered one at a time. Consequently, a liquid current flowing in the direction of the arrow 414 in the pipeline 390 rotates the turbines 386 and 388.

The power generation station 380 may thus be placed into service only when needed, providing a convenient source of power even in remote locations. Moreover, the power generation station 380 may be retrofit into existing pipelines with relatively little impact on the operation of the pipeline.

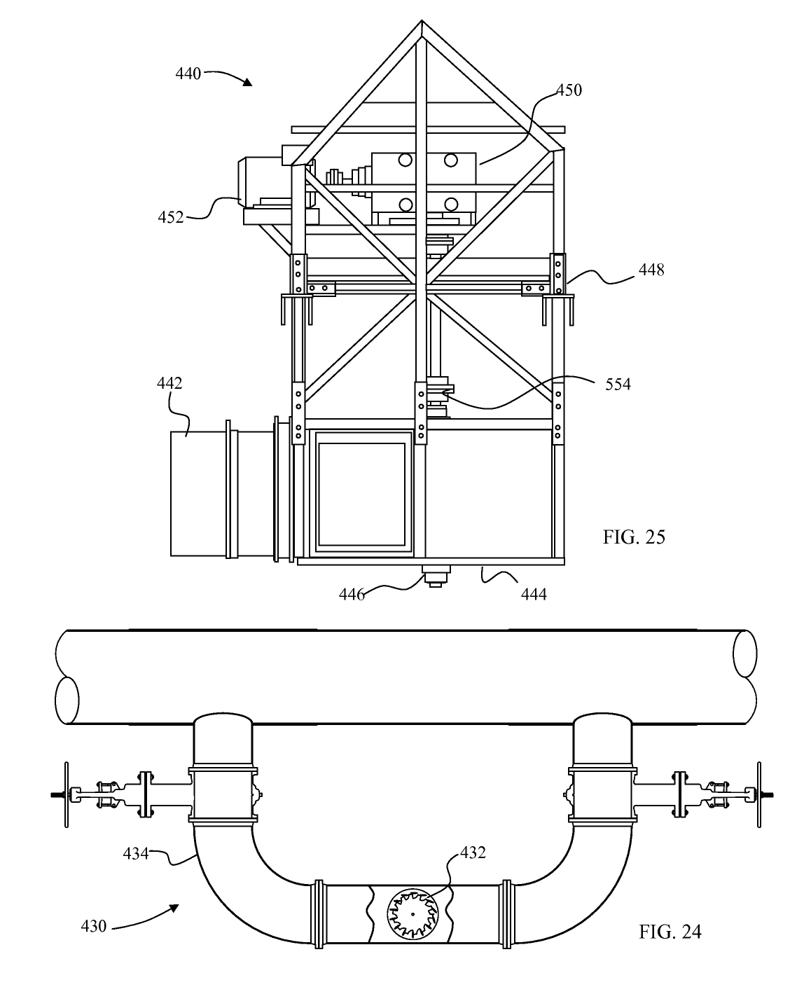

While the embodiments of FIGS. 19-22 include dual turbines, a single turbine may also be used. By way of example, FIG. 23 depicts a power generation station 420 including a single turbine 422. Similarly, FIG. 24 depicts a power generation station 430 with a single turbine 432 positioned within a bypass 434. The embodiment of FIG. 24 does not include a node with shoulders, although one may be incorporated.

The incorporation of hot tap tees allows the power generating stations depicted in FIGS. 19-24 to be easily incorporated into existing pipelines. The power generating stations depicted in FIGS. 19-24 may also be incorporated into new construction pipelines. Alternatively, a power generating station may be permanently installed on a pipeline.

By way of example, FIG. 25 depicts a power generating station 440 that is installed on a pipeline 442. A liquid within the pipeline 442 may be propelled in a current by a pump (not shown) or by gravity. The power generating station 440 includes a turbine (not shown) positioned within a base unit 444. The turbine (not shown) is rotatably supported by a bearing 446. A frame 448 supports a gearbox 450 and a generator 452. The gearbox 450 is connected to the turbine (not shown) through a coupling 454. The power generating station 440 when provided as a unit is particularly suited for new construction. Block valves (not shown) may be provided at the inlet and the outlet of the power generating station 440 to allow isolation of the turbine (not shown) for maintenance.

While the present invention has been illustrated by the description of exemplary processes and system components, and while the various processes and components have been described in considerable detail, applicant does not intend to restrict or in any way limit the scope of the appended claims to such detail. Additional advantages and modifications will also readily appear to those ordinarily skilled in the art. The invention in its broadest aspects is therefore not limited to the specific details, implementations, or illustrative examples shown and described. Accordingly, departures may be made from such details without departing from the spirit or scope of applicant's general inventive concept.

We claim:

1. A power generating system comprising:
a first electric generator;
a first vertical rotor operably connected to the first electric generator and extending into a liquid current; and
a first turbine operably connected to the first vertical rotor and including at least one first end plate and a first vertical louver with a front side, and a back side, and pivotable between a first position whereat the backside is in contact with a first wall portion of the at least one first end plate, and a second position whereat the backside is in contact with a second wall portion of the at least one first end plate.

2. The power generating system of claim 1, further comprising:
a second electric generator;
a second vertical rotor operably connected to the second electric generator and extending into the liquid current; and
a second turbine operably connected to the second vertical rotor and including at least one second end plate and a second vertical louver with a front side, and a back side, and pivotable between a first position whereat the backside is in contact with a first wall portion of the at least one second end plate, and a second position whereat the backside is in contact with a second wall portion of the at least one second end plate.

3. The power generating system of claim 1, further comprising:
a second vertical rotor operably connected to the first electric generator and extending into the liquid current; and
a second turbine operably connected to the second vertical rotor and including at least one second end plate and a second vertical louver with a front side, and a back side, and pivotable between a first position whereat the backside is in contact with a first wall portion of the at least one second end plate, and a second position whereat the backside is in contact with a second wall portion of the at least one second end plate.

4. The power generating system of claim 3, further comprising:
a gearbox operably connected to the first and second vertical rotor and including an output shaft operably connected to the first electric generator.

5. The power generating system of claim 1, further comprising:
a storage chamber configured to receive the first turbine therein; and
a block valve operably connected to the storage chamber and configured to isolate the storage chamber from a liquid current.

6. The power generating system of claim 1, further comprising:
a bypass pipe including an inlet and an outlet; and
a node located between the inlet and the outlet, wherein the first turbine is positioned within the node.

7. The power generating system of claim 6, further comprising:
a second turbine positioned within the node.

8. The power generating system of claim 7, wherein the node comprises:
a shoulder portion extending outwardly from the bypass pipe, a portion of the first turbine positioned with in the shoulder portion.

9. The power generating system of claim 6, further comprising:
a first hot tap tee located at the input; and
a second hot tap tee located at the output.

10. A method of generating electrical power from a liquid current comprising:
positioning a first louver within a liquid current;
impinging a front side of the first louver with the liquid current to transfer a first force to the first louver;
pivoting a backside of the first louver into contact with a first end plate wall structure using the first force;
impinging the back side of the first louver with the water current to transfer a second force to the first louver;
pivoting the back side of the first louver into contact with a second end plate wall structure using the second force; and
rotating a first vertical rotor operably connected to a first electrical generator with the transferred first force and the transferred second force.

11. The method of claim 10, further comprising:
positioning a second louver within the liquid current;
impinging a front side of the second louver with the liquid current;
pivoting the second louver into contact with a third end plate wall structure using a third force generated by the impinging water current; and
rotating a second vertical rotor with the transferred third force.

12. The method of claim 11, further comprising:
opening a block valve positioned between a storage chamber and a hot tap tee; and
lowering the first louver from the storage chamber and into the liquid current through the hot tap tee.

13. A power generating system comprising:
a first turbine operably connected to a first vertical rotor and including a first end plate and a first louver with a front portion, and a back portion, the first louver pivotable between a first position whereat the back portion is in contact with a first wall portion of the first end plate, and a second position whereat the back portion is in contact with a second wall portion of the first end plate; and
a first vertical pivot extending through the first louver and defining a first axis of rotation for the first louver such that the distance from the first axis of rotation to a leading end of the first louver is shorter than the distance from the first axis of rotation to a trailing end of the first louver.

14. The system of claim 13, further comprising:
a second turbine operably connected to a second vertical rotor and including a second end plate and a second louver with a front portion, and a back portion, the second louver pivotable between a first position whereat the back portion is in contact with a first wall portion of the second end plate, and a second position whereat the back portion is in contact with a second wall portion of the second end plate; and
a second vertical pivot extending through the second louver and defining a second axis of rotation for the second louver such that the distance from the second axis of rotation to a leading end of the second louver is shorter than the distance from the second axis of rotation to a trailing end of the second louver; and
a gearbox with an output shaft for coupling with an electric generator, the gearbox operably connected to the first vertical rotor and to the second vertical rotor.

15. The system of claim 13, further comprising:
a storage chamber configured to receive the first turbine therein;
a hot tap tee; and
a block valve operably connected to the storage chamber and the hot tap tee and configured to isolate the storage chamber from a liquid current.

16. The power generating system of claim 13, further comprising:
a bypass pipe including an inlet and an outlet;
a first hot tap tee located at the input; and
a second hot tap tee located at the output, wherein the first turbine is positioned in the bypass pipe between the first hot tap tee and the second hot tap tee.

17. The power generating system of claim 16, further comprising:
a second turbine positioned in the bypass pipe between the first hot tap tee and the second hot tap tee.

18. The power generating system of claim 16, further comprising:
a node including a shoulder portion extending outwardly from a portion of the bypass pipe, wherein a portion of the first turbine is positioned within the shoulder portion.
